(19) United States
(12) Patent Application Publication
(10) Pub. No.: US 2008/0288310 A1
(43) Pub. Date: Nov. 20, 2008

(54) METHODOLOGIES AND SYSTEMS FOR MOBILE MARKETING AND ADVERTISING

(75) Inventors: Janne Aaltonen, Turku (FI); Timo Ahopelto, Helsinki (FI); Geoff Morley, London (GB); Sami Saru, Turku (FI)

Correspondence Address: BARNES & THORNBURG LLP, 750-17TH STREET NW, SUITE 900, WASHINGTON, DC, 20006-4675, US

(73) Assignee: CVON Innovation Services Oy, Turku (FI)

(21) Appl. No.: 12/120,901

(22) Filed: May 15, 2008

Related U.S. Application Data
(60) Provisional application No. 60/924,469, filed on May 16, 2007.

(51) Int. Cl. G06Q 30/00; G06Q 10/00; G06F 15/16

(52) U.S. Cl. 705/7; 705/14; 705/400; 709/201

(57) ABSTRACT

Methods and systems analyze the efficacy of mobile marketing and advertising taking into account more than those attributes which were originally selected for the selected target profile(s) associated with a mobile marketing or marketing or advertising campaign. More specifically, the analysis includes consideration of profile attributes that need not be subsets of the specified profile attributes. The analysis results may then be used to manage future mobile marketing or marketing or advertising campaigns or campaign phases more effectively.

This application is a U.S. patent application that relies for priority under 35 U.S.C. 120 on Provisional Application Ser. No. 60/924,469 filed on May 16, 2007, which is incorporated herein by reference.

The invention relates in general to marketing and advertising campaigns directed to mobile device users. In particular the invention relates to methods, systems and software for managing, delivering and assessing the efficacy of marketing and advertising campaign content distribution, as specified in the preamble of the independent claims.

### BACKGROUND OF THE INVENTION

Targeting the correct audience and measuring impact are key problems of any advertising or marketing activity, whether it is in the field of direct marketing or brand advertising. These problems are also suffered by “mobile marketing,” which involves and relates to marketing and advertising via mobile devices, e.g., phones, smart phones, and Personal Data Assistants (PDAs), receiving promotional material, i.e., marketing and/or advertising content in the form of, e.g., text, audio, video or some combination thereof associated with a particular product, service or combination thereof.

Mobile marketing enables advertisers to directly reach individual consumers in a targeted way. This is because the nature of mobile media is personal, in that mobile devices are generally used by a particular individual rather than a group of individuals. Further, mobile media is, by definition, mobile, which offers a transportable mechanism for exposing potential consumers to promotional material. Moreover, because mobile media is “always on,” advertisers are not constrained by the need to make a connection in order to deliver promotional material to a user's device because a connection is always established with a user's mobile device (provided the mobile device is in range of an available communication network). As an additional benefit of mobile media as an advertising mechanism, mobile media enables groups of individuals to form wherein the group members communicate actively with each other. As a result, these characteristics combined with social networks-based marketing approach of the Internet may form a very powerful base to execute marketing strategies.

There is a cost associated with this targeted distribution of promotional material. Typically a cost is associated with delivery of a direct advertisement message to a targeted individual (i.e., someone who has the attributes identified in an advertising campaign) by direct marketing, or media space in brand advertising. Therefore, an advertiser may limit the amount of promotional material, e.g., number advertising content messages, to be sent, carefully balance the cost of media space, by sending promotional material only to a limited number of all possible targeted individuals, or booking only very limited channels, i.e., the methodologies or media by which promotional material is transmitted.

Limiting the targeted individuals to receive promotional material is typically performed either be selecting targeted individuals randomly or by using information about targeted individuals, i.e., using their profile information. However, the delivery of promotional material for direct marketing based on random selection is likely to produce an unsuccessful marketing or advertising campaign; accordingly, a response rate for such a campaign would have no or very little beneficial impact on the advertiser's business.

Also the delivery of promotional material in a direct marketing campaign based on profiles can also result in an unsuccessful campaign if the profile of the target audience is set poorly or incorrectly; that is, when a marketing or advertising campaign's target audience profile does not match the promotional material in the marketing or advertising campaign (i.e., it is not persuasive to the target audience), then the campaign may be unsuccessful.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, the management or implementation of at least one marketing or advertising campaign is performed as indicated in the independent claims of the present application. This is achieved by a combination of features recited in each independent claim. Accordingly, dependent claims prescribe further detailed implementations of the present invention.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates an advertising environment wherein embodiments of the invention may be utilized.

FIG. 2 illustrates additional details included in an advertisement managements system provided in accordance with at least one embodiment of the invention.

FIG. 3 illustrates further details included in an efficacy feedback determination mechanism provided in accordance with at least one embodiment of the invention.

FIGS. 4-9 illustrate graphical depictions of various advertisement campaign efficacy scenarios provided to aid in the understanding of the utility of the invention.

FIG. 10 illustrates a method of managing a marketing or advertising campaign in accordance with at least one embodiment of the invention.

FIG. 11 illustrates another method of managing a marketing or advertising campaign in accordance with at least one embodiment of the invention.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in the respect.

In general, mobile marketing and advertising activities can be divided into four categories: mobile Customer Relation Management (CRM), mobile marketing, mobile advertising, and mobile direct advertising. Mobile CRM involves a combination mobile advertising, mobile marketing and mobile direct marking (each explained herein) in a manner that establishes a long-term, engaging relationship between the customer and the promoting company.

Mobile marketing involves the systematic planning, implementation and control of a mix of business activities intended to bring together buyers and sellers for the mutually advantageous exchange or transfer of products or services where the primary point of contact with the potential consumer is via their mobile device. To the contrary, mobile advertising may be thought of more narrowly as the paid, public, non-personal announcement of a persuasive message by an identified sponsor (i.e., advertiser), the non-personal presentation or promotion by a firm of its products to its existing and potential customers where such communication is delivered to a mobile phone or other mobile device. Examples of mobile advertising would include: Wireless Application Protocol (WAP) banner advertisements, mobile search advertising, mobile video bumpers, and interstitial advertisements.

One challenge faced by mobile marketing and advertising campaigns is implementing conventional marketing and advertising principals in the technologically unique advertising channel of mobile media. Mobile marketing and advertising is mostly based on “push campaigns” that broadcast promotional material to individuals listed in a consumer mobile number database; in such campaigns, consumers can opt into a campaign, thereby agreeing to receive the type and quantity of promotional material determined by the advertiser and at the frequency determined by the advertiser.

To the contrary “pull campaigns” acquire mobile device phone numbers or electronic mail addresses directly from the mobile device users; the most typical example of the pull campaign is the “text-to-win” campaign were, e.g., a soft drink bottle contains a short alphanumerical code to be sent by the mobile device user via text message to a specified phone number. In return, for providing contact information and, optionally, additional information that may be used to profile the user (e.g., gender, age, interests, etc.) the mobile device user may receive a notification if they have won an associated prize along with a selected marketing message or series of messages being broadcast to their mobile device.

Mobile direct marketing differs from mobile marketing typically in that direct marketing involves promotional material being delivered to a mobile device on an individual basis. Accordingly, examples of mobile direct marketing include the sending of Short Messaging Service (SMS), Multimedia Messaging Service (MMS) or WAP push messages, Bluetooth messaging and other interrupt-based marketing to mobile devices. Such direct marketing often uses text and picture messaging.

Direct marketing, be it mobile, Internet-based or conventional, generally utilizes consumer profile information to ensure that promotional material designed to be effective with a particular type of consumer is sent to that type of consumer. Accordingly, as a marketing or advertising campaign is formulated, an advertiser will identify what particular attributes the target audience will have, e.g., age, gender, economic status, marital status, interests, etc. Conventionally, systems are available that enable advertisers to identify these target profile attributes via a user interface provided in combination with a profile selection tool software program. By interacting with the user interface, advertisers may select a profile(s) of attributes to which the promotional material is then to be directed.

As explained above, there is a cost associated with this targeted distribution of promotional material. Therefore, an advertiser may limit the amount of promotional material. Limiting the targeted individuals to receive promotional material is typically performed either be selecting targeted individuals randomly or by using information about targeted individuals, i.e., using their profile information. However, the delivery of promotional material for direct marketing based on random selection is likely to produce an unsuccessful marketing or advertising campaign. Also the delivery of promotional material in a direct marketing campaign based on profiles can also result in an unsuccessful campaign if the profile of the target audience is set poorly or incorrectly. Accordingly, response rates for such campaigns would have very little beneficial impact on an advertiser's business.

In conventional direct marketing advertising campaign management, available consumer profiles are used to target advertising and marketing campaigns. That is, an advertiser selects one or more profiles of a target audience to which promotional material is to be sent; subsequently, the promotional material is sent to individuals with that profile listed in a consumer database. The effect of the campaign is then studied, after the campaign, against the selected profile by the advertiser or media agencies, consultancy companies or other similar professionals to determine the marketing or advertising campaign's efficacy.

As an example, presume an advertiser would like to send promotional material to both males and females as part of a marketing or advertising campaign. Following completion of the campaign, a media agency then determines how many individuals responded to the promotional material in the campaign. A response may be, for example, interaction with the promotional material, purchase of a product associated with the promotional material, specific action prompted by the promotional material, etc. For example, it may be determined how many individuals with the specified profile(s) responded to the promotional material. Additionally, the analysis may further breakdown the responding individuals into subsets of the target provide by age or gender. Such post-campaign analysis may be performed using conventional research methods.

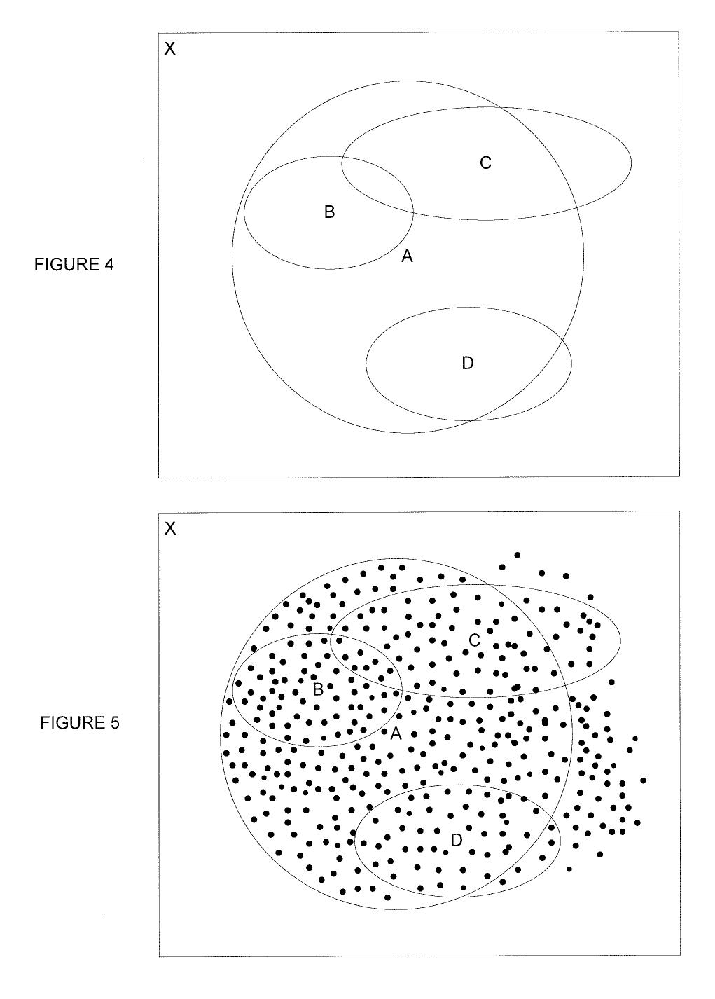

To the contrary, in accordance with at least one embodiment of the invention, methodologies and systems analyze the efficacy of a marketing or advertising campaign by taking into account more than those profile attributes that were originally selected by an advertiser for the selected campaign target profile(s). More specifically, the analysis includes analysis of attributes that need not be subsets of the specified attributes (as explained in connection with FIGS. 4-9 herein).

In accordance with at least one embodiment of the invention, a methodology is provided for managing or implementing at least one marketing or advertising campaign based on profile information including data indicating whether individuals have one or more various attributes. As part of this methodology, data is collected regarding the effect of promotional material associated with a marketing or advertising campaign on the individuals included in a profile associated with the marketing or advertising campaign and also individuals having attributes not included in that target profile. As a result, it may be determined whether the promotional material was effective at promoting a response with individuals included in the campaign's target profile and also the effect on other individuals.

In accordance with at least one embodiment of the invention, campaign efficacy information indicating the promotional material's resulting effect on both individuals within the targeted profile and other than the targeted profile may be obtained based on an initial campaign phase using mobile marketing and/or mobile direct marketing techniques. Subsequently, that information may be used to refine one or more subsequent phases of promotional material via direct marketing, wherein the target profile and/or the promotional material may be adjusted to provide a more effective campaign.

In accordance with at least one embodiment of the invention, campaign efficacy information indicating the promotional material's resulting effect on both individuals within the targeted profile and other than the targeted profile may be provided by an advertising channel provider or other similar entity.

Accordingly, the invention enables management, implementation and analysis of at least one marketing or advertising campaign based on profile information including data indicating whether individuals have one or more various attributes. As part of this methodology, data is collected regarding the effect of promotional material associated with a marketing or advertising campaign on the individuals included in the campaign's target profile and also individuals not included in that profile. As a result, it may be determined whether the promotional material was effective with individuals included in the targeted profile for the marketing or advertising campaign and also the effect on other individuals. These analysis results may then be used to tailor future marketing or advertising campaigns or campaign phases more effectively.

As explained above, individual profiles may include data indicating various attributes, e.g., a preference for a particular type of food, ownership of a particular mode of transportation, residence in a particular geographic area, etc. FIG. 4 is a Venn diagram illustrating overlap of four subsets A-D in a particular universal set of individuals X. The universal set of individuals X may be considered to include, for the purposes of the following example, the total number of profiled individuals, e.g., those individuals for which some amount of information is associated with each individual.

As illustrated in FIG. 5, the dots within the universal set X depict individuals included in the universal set X. As illustrated, the universal set of individuals X includes individuals not included in any of the subsets A-D; thus, those individuals are represented by dots within X but outside of any of subsets A-D.

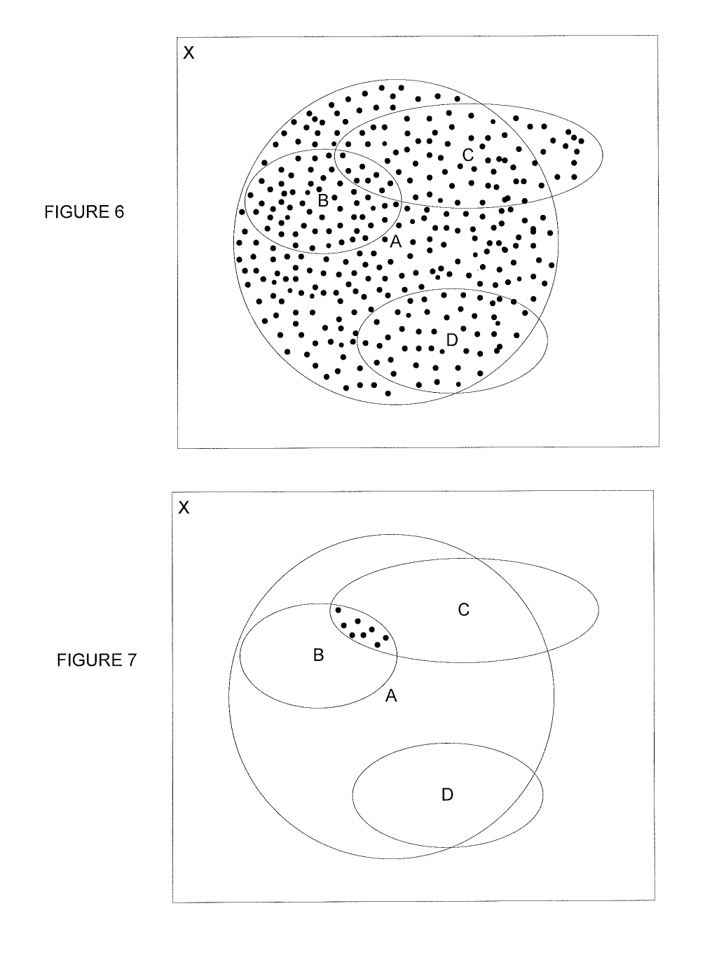

Likewise, the subsets A-D illustrate the groups of individuals within the universal set X that have specific attribute(s) associated with the specified subsets, A-D. For example, as illustrated in FIG. 6, suppose the subset A represents the group of individuals having the attribute of living in California; similarly, subset B represents the group of individuals having the attribute that those individuals like to go out for dinner, subset C refers to the group of individuals who have the attribute that they each prefer soft drink 1 over soft drink 2 and subset D refers to those individuals having the attribute that these individuals own a bicycle.

Based on this example, it can be understood that (as shown in FIG. 5), in the universal set X, all profiled consumers who like to go out for dinner (attribute-specific subset B) also live in California (attribute-specific subset A) since attribute-specific subset B is a further subset of attribute-specific subset A. In addition, one can see that there is a group of consumers who live in California (attribute-specific subset A) AND like to go out (attribute-specific subset B) AND prefer soft drink 1 over soft drink 2 (subset C). As a result, this subset of individuals may be logically defined as A∩(AND)B∩(AND)C. Also, FIG. 5 illustrates that, in this example, all of those profiled individuals who have a bicycle (attribute-specific subset D) also do not like to go out for dinner (subset B) and do not prefer soft drink 1 over soft drink 2 (subset C). Additionally, it may be understood that some of the bicycle owners (subset D) are not living in California (subset A).

Thus, using conventional advertising techniques, an advertiser interested in directing or targeting promotional material to individuals belonging to subset A∪(OR)[A∩(AND)C], would conventionally use profile information indicating attributes A, B and C but not D.

To the contrary, in accordance with at least one embodiment of the invention, methodologies and systems provide the value added service that, an advertiser may be provided with campaign efficacy data that takes into account audience attributes that are not included in the campaign's target profile. This is because invention embodiments can analyze the efficacy of a marketing or advertising campaign taking into account more than those attributes which were initially selected by an advertiser for the selected campaign target profile(s).

More specifically, the analysis includes attributes that need not be subsets of the initially specified attributes; that is, because all bicycle owners have a gender and an age, gender and age may be subsets of a bicycle owner subset. However, there is no necessary attribute relationship between bicycle ownership and an interest in environmental conservation. Thus, the attribute of environmental conservation interest need not be a subset of a bicycle ownership subset. Nevertheless, in accordance with at least one embodiment of the invention, promotional material efficacy may be determined for those individuals having an interest in environmental conservation even though a campaign's target profile only targets bicycle owners. The analysis results may then be used to tailor future marketing or advertising campaigns or campaign phases more effectively, e.g., to bicycle owners also interested in environmental conservation.

Thus, in accordance with at least one embodiment of the invention, analysis may be performed of the profile attributes of those individuals responding to an initial phase of a marketing or advertising campaign; however, analysis is performed of attributes other than just those specified in an initial target audience profile. Thus, according to at least one embodiment of the invention, a determination may be made whether there is a correlation between the marketing or advertising campaign response rate and profile attributes other than those initially specified. As a result, in accordance with at least one embodiment of the invention, an advertising managements system may be provided that enables effective distribution of promotional material to target audiences.

Further, in accordance with at least one embodiment of the invention, an efficacy feedback mechanism is provided. It should be understood that this feedback mechanism collect information about how well the advertisement campaign was received by consumers. The source of the information may be, for example, individuals' direct answer to questionnaire, actions related to promotional material, purchase of good or service related to promotional material, indirect or direct action related to promotional material, etc. The utility of this feedback mechanism will now be explained in connection with various scenarios related to the above-example.

As a first result scenario, assume that promotional material is distributed to individuals within subsets A or C [A∪C] as part of a marketing or advertising campaign (see FIG. 6). However, analysis of promotional material responses indicated that all who responded to the promotional material were members of subsets A, B and C [A∩B∩C] (see FIG. 7). By comparing the intended efficacy profile [A∪C] with the actual efficacy profile [A∩B∩C], it can be concluded that the promotional material was successful for those individuals in the A, B and C subsets [A∩B∩C]. This information can be used to configure subsequent marketing or advertising campaign activity to be more efficient by either directing the promotional material to those within subsets A, B and C [A∩B∩C] or altering the promotional material to have a broader appeal and elicit responses from individuals beyond those included within A, B and C [A∩B∩C].

It should be appreciated that, in accordance with conventional directed advertising techniques, post-campaign analysis would merely indicate, for example, 5% of A and 10% of C responded to the promotional material. To the contrary, in accordance with at least one embodiment of the invention, data is available which may indicate not only what percentages of specified target attribute-specific subsets were responsive, e.g., 5% of A and 10% of C, but also percentages of combinations of specified and unspecified attribute-specific subsets, e.g., 80% of A∩B∩C, 10% of A∩B, 0% of A∩D, etc.

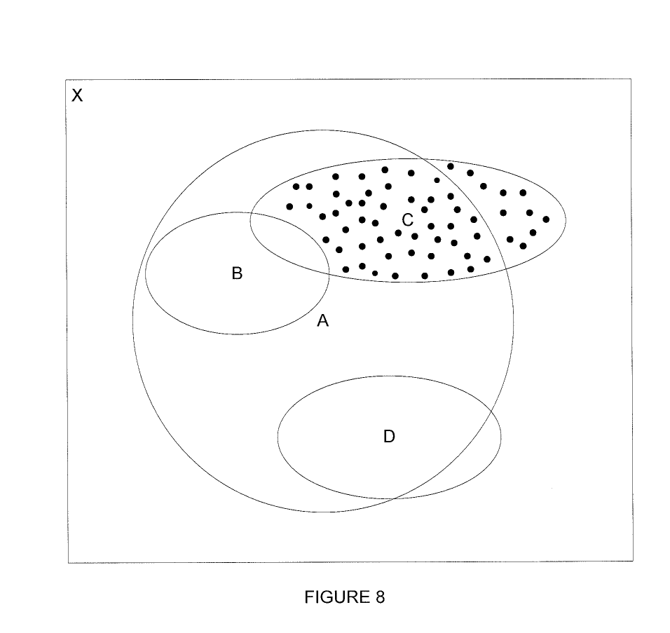

To further illustrate the utility of the invention embodiments, presume another scenario wherein distribution of promotional material intended to be effective for a target profile [B∪C] actually resulted in responses to promotional material being concentrated in the attribute-specific subset C but not the attribute-specific subset B (see FIG. 8). In accordance with at least one embodiment of the invention, feedback data may be generated that includes information indicating that the response rate for the attribute-specific subset C was 60%, but the response rate of the attribute-specific subset C not B [C∩NOT B] was even higher at 80%; accordingly, subsequent marketing or advertising activity may be revised to alter the target profile to be [C∩NOT B].

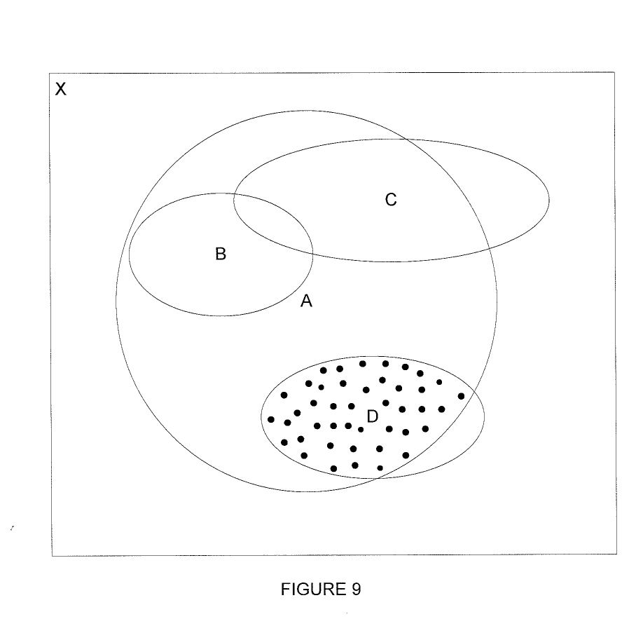

An alternative scenario might be as illustrated in FIG. 9, wherein an distribution of promotional material is intended to be effective for a target profile [A∪B∪C]; however, those individuals belonging to both attribute-specific subsets A and D [A∩D] were actually most responsive to the promotional material. With such information, distribution of promotional material for subsequent campaign activity may be based on attribute D. Further, additional efficacy analysis may be used to determine if a campaign based only on distributing to individuals having attribute D would likely be effective.

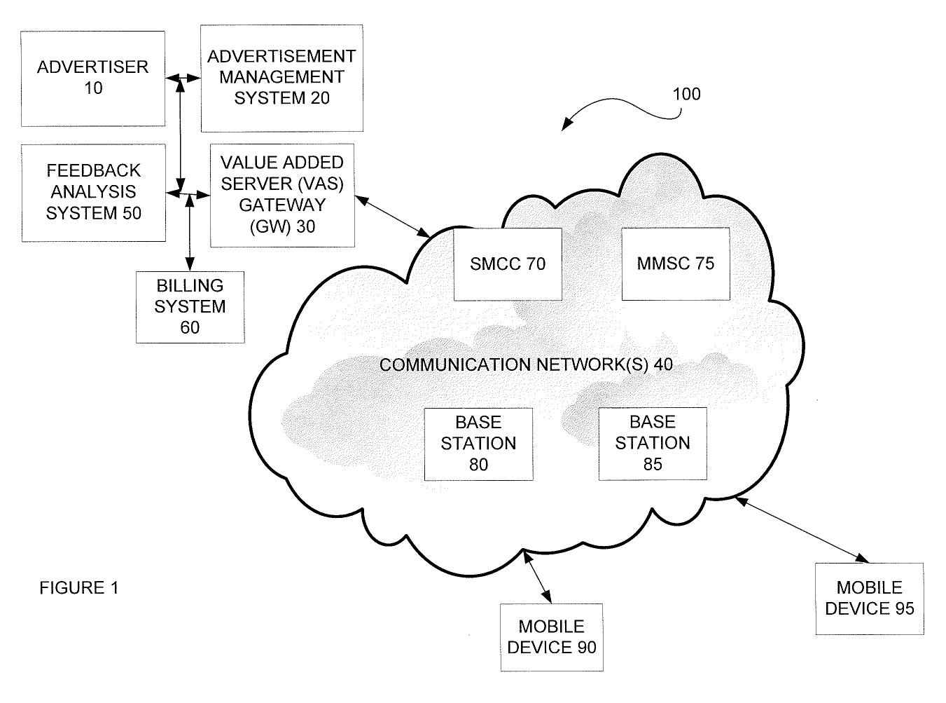

With this understanding of the utility of embodiments of the invention in mind, a description of the architecture and operation of various invention embodiments is now provided. Thus, returning to FIG. 1, an advertising environment 100 is illustrated that includes components of various embodiment so the invention. Embodiments of the invention may be utilized in environment 100 to provide improved mobile marketing and/or advertising campaign efficacy.

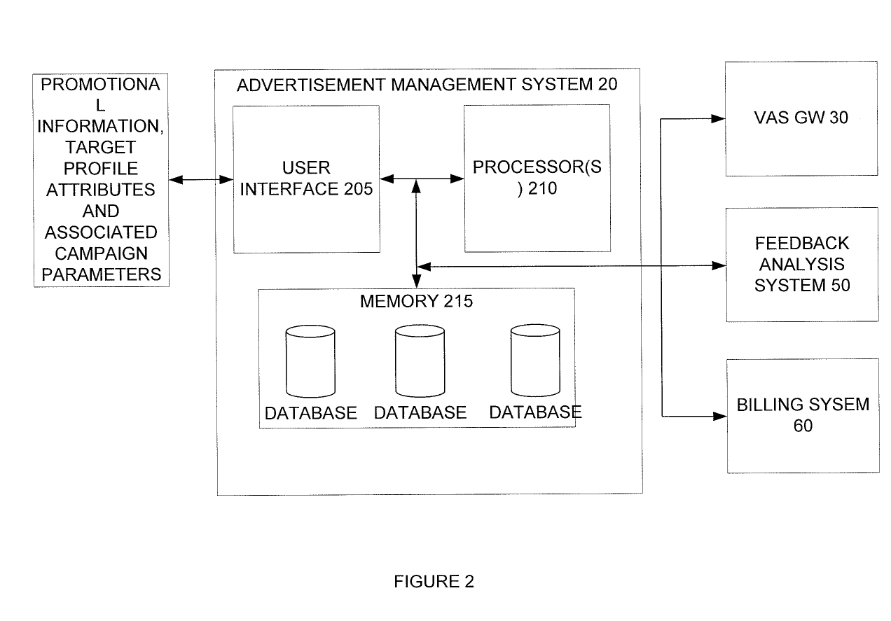

As illustrated in FIG. 1, an advertiser 10 (which may be an advertiser, advertising firm, media agency, consultancy company or other similar entity interested in determining a marketing or advertising campaign's efficacy) may access the advertisement management system 20 (illustrated in further detail in FIG. 2) in order to manage and control distribution of promotional material in connection with one or more marketing or advertising campaigns.

The advertisement management system 20 is operationally coupled to the Value Added Service (VAS) GateWay (GW) 30, which can be used to execute the campaign and deliver information about the campaign back to the advertisement management system 20. As such, the VAS GW 30 may be implemented in whole or in part using one or more intermediate servers between the advertisement management system 20 or with the system 20 and the one or more communication networks 40. Alternatively, the VAS GW 30 may be implemented in combination with the advertisement management system 20.

The one or more communication networks 40 may include any type of communications network including but not limited to a second Generation (2G) network, a 2.5 Generation network, a third Generation (3G) network utilizing Global System for Mobile Communications (GSM), Wideband Code Division Multiplex Access (WCDMA), Code Division Multiplex Access (CDMA), or Time Division Multiplex Access (TDMA), General Packet Radio Services (GPRS), Universal Mobile Telephone System (UMTS). Further, the one or more communication networks 40 may also include local area networks, such as Wireless Local Area Networks (WLAN), BlueTooth (BT) and optionally utilize one or more other technologies, such as WiMax (WorldwideInteroperability for Microwave Access). Communication via the one or more communication networks 40 may be implemented by broadcasting over cellular, broadcasting over DVB-H (Digital Video Broadcasting—Handhelds), ISDB-T (Terrestrial Integrated Services Digital Broadcasting) or DMB (Digital Multimedia Broadcasting). Further, optionally, MediaFlo™ may be used to provide a connection and to deliver a service. The one or more communication networks 40 can also include any other type of network of interconnected devices or device networks, e.g., interconnected computers or computer networks. Accordingly, it should be understood that the one or more communication networks 40 can also be a combination of a plurality of different types of networks forming one or more hybrid networks.

The one or more communication networks 40 may include one or more Short Message Service Centers (SMSC) 70 and Multimedia Message Service Centers 75. Multimedia Messaging Service. Accordingly, the one or more communication networks 40 may enable transmission of SMS and MMS messages.

The one or more communication networks 40 may further include one or more base stations 80, 85 wireless communications station installed at a fixed location and used to communicate as part of either a push-to-talk two-way radio system or a wireless telephone system, for example, cellular, CDMA or GSM.

A feedback analysis system 50 may be configured to perform analysis of the promotional material response rates for target profile attributes as well as attributes other than just those specified in target profile(s). Further, the feedback analysis system may be configured to generate a correlation(s) between promotional material response rates and profile attributes including attributes other than those specified in a target profile.

Further, the feedback analysis system 50 may be coupled to the VAS GW 20 to communicate feedback analysis data such as response rates and correlation data with the advertisement management system 20 for use by the advertiser 10. However, it should be understood that, although not shown, the feedback analysis system 50 may be directly connected to the advertisement management system 20 or the advertiser 10 via one or more communication networks, which optionally, may include communication network(s) 40.

The one or more communication networks 40 may provide operational coupling between a billing system 60 and the VAS GW 20 or directly with the advertisement management system 20. It should be understood that the billing system 60 may also be configured to receive information from the feedback analysis system 50 and to determine cost of distribution of promotional material based on that received information.

Once an advertiser has provided data indicating how promotional material is to be distributed in connection with a marketing and/or advertising campaign, the information may be used to deliver the promotional material via the one or more communication networks 40 to one or more mobile devices 90, 95 (as explained in greater detail in connection with FIG. 2).

Each of the mobile devices 90, 95 can be implemented as a mobile phone, lap top, PDA, multimedia computer, etc. Accordingly, although not illustrated, it should be understood that a mobile device 90, 95 may include a processor connected to a user interface, computer readable memory and/or other data storage and a display. The mobile device may also include a battery, speaker and at least one antenna. The user interface may further include a keypad, touch screen, voice interface, one or more arrow keys, joy-stick, data glove, mouse, roller ball, touch screen or the like.

Accordingly, computer executable instructions and data used by a processor included in a mobile device 90, 95 and other components within the mobile device may be stored in the computer readable memory included the mobile device. Further, the memory may be implemented with any combination of read only memory modules or random access memory modules, optionally including both volatile and nonvolatile memory. Further, software may be stored within the memory and/or storage to provide instructions to the mobile device's processor for enabling the mobile device to perform various functions. Alternatively, some or all of the mobile device computer executable instructions may be embodied in hardware or firmware (not illustrated).

As illustrated in FIG. 2, the advertisement management system 20 may include one or more processors 205 operationally coupled to a user interface 210, computer readable memory and/or other data storage 215. Accordingly, computer executable instructions and data used by the processor(s) 205 and other components within the advertisement management system 20 may be stored in the computer readable memory included the advertisement management system 20. Further, software may be stored within the memory and/or storage 215 (coupled to the processor(s) 205 and user interface 210) to provide instructions to the advertising management system components for enabling the system 20 to perform various functions.

For example, the advertising management system 20 may be configured to receive promotional material and/or profile attributes associated with marketing and/or advertising campaigns as well as other details regarding distribution of such promotional material via the user interface 210. Subsequently that information may be stored in one or more databases included in the computer readable memory and/or other data storage 215. Accordingly, the user interface 210 may be configured to enable an advertiser 10 or other entity to interact with components of the advertisement management system 20 as well as other systems coupled to the system 20 such as VAS GW 30, feedback analysis system 50 and billing system 60 to manage and control distribution of promotional material and analysis of responses thereto as part of one or more marketing or advertising campaigns. Accordingly, the user interface 210 may be implemented as a web-based user interface provided by software stored in the memory 215 or running on one or more servers associated with or supporting the advertisement management system 20.

The memory 215 may include one or more databases configured to store individual-specific profile information indicating one or more attributes of individuals to optionally receive promotional material. An example of such profile information can include an individual's age, gender, zip code, food preferences, music preferences, movie preferences, etc. Additionally, memory 215 may include additional databases for storing promotional material archive information, which may indicate what promotional material has been sent to specific individuals in the past, the type of promotional material (e.g., SMS, couponing, text-to-win campaign material) and the individuals' responses to the promotional material. Additionally, the memory 215 may also include one or more databases for storing actual promotional material and related distribution parameters for use in distributing the promotional material in connection with campaigns.

It should be understood that memory 215 may include many databases that separately include, for example, profile attribute information, promotional material, archive data, etc. or some combination or all of this information and data may be included in a single database.

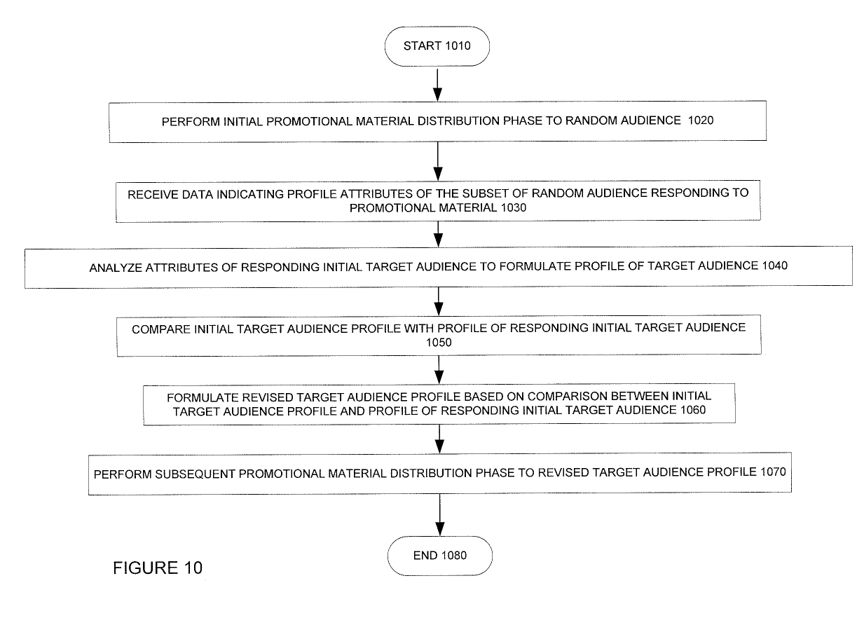

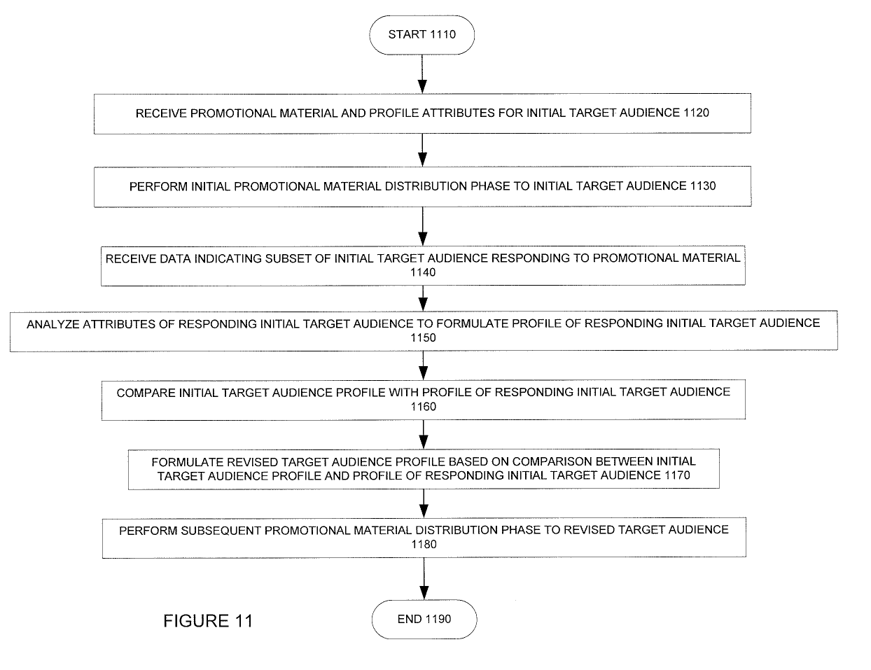

Following receipt of both profile attribute data and promotional material for a campaign, the advertisement management system (in connection with the VAS GW 30) may distribute promotional materials to individuals using the at least one communication network 40. As explained in connection with methodologies provided in accordance various invention embodiments (see FIGS. 10 and 11), such distribution may be performed as mobile marketing or mobile direct marketing (involving specified target profile attributes).

Mobile device users may respond to such promotional materials directly via the at least one communication network 40 and/or feedback can be indirect via one or more alternative systems (not shown), for example, through use of coupons, debits or tokens, by purchasing advertised products or services, etc.

Once mobile device users respond to the distributed promotional material, information indicating the type of response, the identity of the responder and other details regarding the response (timing, manner, associated mobile device user actions such as forwarding promotional material, etc.), that information is collected by the feedback analysis system 50 via, for example, the one or more communication networks 40 and/or alternative systems (not shown).

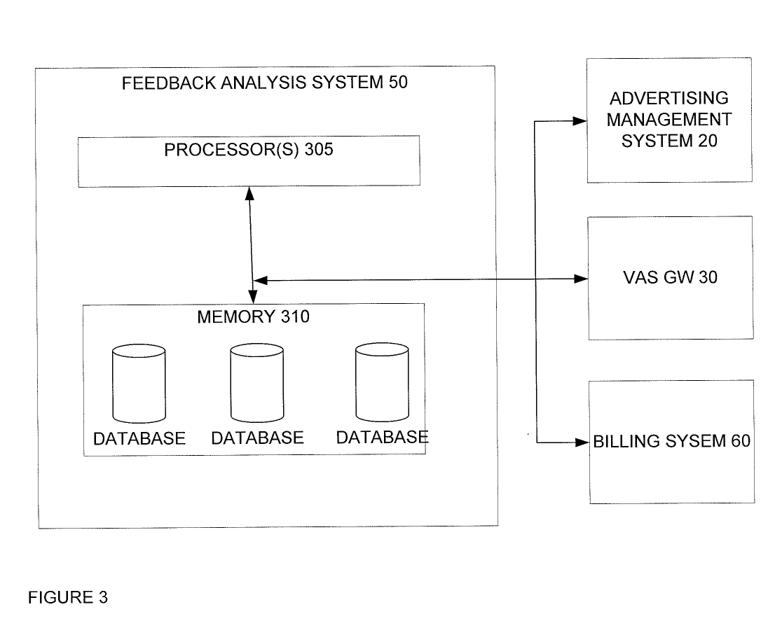

As illustrated in FIG. 3, the feedback analysis system 50 may include one or more processors 305 and computer readable memory and/or other data storage 310. Accordingly, computer executable instructions and data used by the processor 305 and other components within the feedback analysis system 50 may be stored in the computer readable memory 310 included the feedback analysis system 50. Further, software may be stored within the memory and/or storage 310 to provide instructions to the feedback analysis system components for enabling the system 50 to perform various functions.

For example, the feedback analysis system 50 may receive data indicating specific information regarding responses from individuals who received promotional material. Further, the feedback analysis system 50 may be configured to analyze the response data and determine correlations with profile attributes not originally selected by the advertiser. As a result, the feedback analysis system 50 may be configured to access data stored in the memory 215 of the advertisement management system 20; however, the feedback analysis system 50 is configured to perform correlation analysis for attributes other than those specified by the advisor 10.

Following this analysis, the feedback analysis system 50 may also be configured to generate data from the comparison of response rates for the advertiser initiated target profile attributes for the promotional material distribution (input to the advertisement management system 2) and attributes other than those indicated in the advertiser initiated target profile. Subsequent to the analysis of the feedback analysis system 50, the generated results are transmitted back to the advertisement managements system 20 for review by the advertiser in whole or in part. Additionally, the billing system 60 may have access to the feedback analysis system's generated data to prepare one or more billing statements indicating a cost of the distribution of the promotional material, and, optionally, alternative costs associated with targeting other profile attributes (e.g., those identified as effective at achieving high response rates).

Although not explained in detail above, it should be understood that the advertisement management system 20, the VAS GW 30, feedback analysis system 50 and billing system may each or all be implemented using one or more servers including software to coordinate, implement, analyze and report on the delivery of the promotional material to targeted individuals based on parameters such as promotional material delivery time, method, target consumers, target profiles, etc.

Turning to the operation of invention embodiments, it should be understood that campaign efficacy information indicating promotional material's resulting effect on both individuals within a targeted profile and other than the targeted profile may be obtained based on an initial advertisement campaign phase, either via mobile marketing, mobile direct marketing or some combination thereof. FIG. 10 illustrates operation of a methodology provided in connection with at least one invention embodiment, wherein an initial phase of a marketing or advertising campaign or other type of promotional activity distributes promotional material to individuals randomly. However, it should be understood that this “random” distribution may be of various types.

For example, an initial phase may involve text messaging all subscribers to a particular mobile service provider (that attribute being subset E of a universal set X (not illustrated)). Alternatively, the initial phase may involve text messaging a random subset of those subscribers in subset A. Moreover, the initial phase may involve text messaging a random subset of those subscribers in subset A who have the ability to configure ring tones on their mobile device (that attribute being subset F of a universal set X (not illustrated)).

Further, an initial phase may involve SMS messaging random device phone numbers; such an initial phase would provide some subset of the universal set X. It should be understood that such an initial phase of a marketing or advertising campaign would likely not be considered direct marketing because it would not be based on profile attribute data associated with individuals. However, responses to such an initial phase of marketing could be used to generate profile information regarding those individuals that respond to that initial phase, e.g., one attribute being that the individual has the ability to respond to SMS messaging and another being that the individual has responded in the past to SMS messaging.

Returning to FIG. 10, operations begin at 1010 and control proceeds to 1020, at which an initial promotional material distribution phase is performed to distribute promotional material to a “random” selection of individuals. Subsequently, at 1030, data is received indicating profile attributes of the subset of individuals responding to the distributed promotional material. That data is analyzed at 1040 to formulate a profile of the responding initial target audience. Subsequently, the initial target audience profile is compared with the profile of the responding initial target audience at 1050. Based on that comparison, a revised target audience profile is formulated at 1060. Control then proceeds to 1070, wherein subsequent promotional material distribution is performed based on the revised target audience profile. It should be appreciated that promotional material distributed at 1070 may be the same, different or related to the promotional material distributed at 1020, in terms of actual content, type of distribution, e.g., SMS, MMS, etc., and theory of advertising, e.g., coupon, free download, prize drawing, etc. Control then proceeds to 1080 where operations associated with a particular marketing or advertising campaign may cease.

It should be understood that, although not shown, more than one iteration of any or all of the operations illustrated at 1020-1070 may be performed to provide more targeted distribution of promotional material.

In accordance with at least one embodiment of the invention, campaign efficacy information indicating the promotional material's resulting effect on both individuals within the targeted profile and other than the targeted profile may be obtained based on an initial advertisement campaign phase via mobile direct marketing. Subsequently, that information may be used to refine one or more subsequent phases of promotional material distribution via direct marketing, wherein the target audience profile and/or the promotional material may be adjusted to provide a more effective campaign. FIG. 11 illustrates such operation wherein an initial phase of a marketing or advertising campaign distributes promotional material to individuals via mobile direct marketing, i.e., based on some amount of profile information.

As illustrated in FIG. 11, operations begin at 1110 and control proceeds to 1120, at which promotional material and an profile attributes for an initial promotional material distribution phase are received from, for example, an advertiser or advertising firm. Control then proceeds to 1130, wherein an initial promotional material distribution phase is performed to distribute promotional material to a “random” selection of individuals.

It should be understood that this “random” selection can also be an initial target group of individuals defined based on profile information. For example, an advertiser may order an advertising campaign targeting a group of 100 individuals with profile attributes A and B. The total subset of A and B in a system may be 10,000 individuals; thus, a mobile advertising provider may then perform an initial distribution of promotional material for a randomly selected 100 individuals from that subset. If the response rate to the initial promotional distribution is sufficient (as deemed by the advertising provider or the advertiser and/or as specified for the advertising campaign), the advertising provider may then send this result on behalf of the advertiser as a result. However, if the response rate is insufficient, the advertiser provider may analyze the results based on the invention to find additional profile parameters of individuals who responded to the initial distribution of promotional material.

Subsequently, at 1140, data is received indicating profile attributes of the subset of individuals responding to the distributed promotional material. That data is analyzed at 1150 to formulate a profile of the responding initial target audience. Subsequently, the initial target audience profile is compared with the profile of the responding initial target audience at 1160. Based on that comparison, a revised target audience profile is formulated at 1170. Control then proceeds to 1180, wherein subsequent promotional material distribution is performed based on the revised target audience profile. It should be appreciated that promotional material distributed at 1180 may be the same, different or related to the promotional material distributed at 1120, in terms of actual content, type of distribution, e.g., SMS, MMS, etc., and theory of advertising, e.g., coupon, free download, prize drawing, etc. Control then proceeds to 1190 where operations associated with a particular marketing or advertising campaign may cease.

As in the embodiment illustrated in FIG. 10, it should be understood that, although not shown, more than one iteration of any or all of the operations illustrated at 1130-1180 may be performed to provide more targeted distribution of promotional material.

In connection with the operations provided in FIGS. 10 and 11, it should be understood that it is also possible that an advertising channel provider (e.g., a mobile electronic mail provider) may have historical data relating to similar marketing or advertising campaigns and response rates thereof. This data can be also used either by the advertiser or by the channel provider to improve the response rate by, for example, utilizing this data at 1020 in FIG. 10 (to provide a quasi-random distribution of promotional material) or including the data in data to be analyzed at 1040 in FIG. 10 or 1150 in FIG. 11 (to improve a broader temporal understanding of the response rate to promotional material).

As should be understood by one of ordinary skill in the art from the description provided herein, mobile marketing or advertising campaign efficacy information can be used by advertisers and advertising firms to improve the efficacy of marketing or advertising campaigns. Moreover, the marketing or advertising campaign efficacy information provided by embodiments of the invention can also or alternatively be used by advertising channel providers to improve mobile marketing or advertising campaign response rates by more efficiently and effectively using the advertising channel.

Moreover, such an implementation may be of particular utility to advertising channel providers to increase profit because the invention would provide a mechanism for determining mobile marketing and advertising campaign efficacy. More specifically, an advertising channel provider's profits increase when a response rate increases. This is due to the fact that typically advertising is priced on a two-tiered approach: there is a basic price for sending promotional material to a mobile device and, if the targeted individual responds to the promotional material (e.g., by replying to the promotional material) the advertiser pays an additional fee to the advertising channel provider. Accordingly, when an advertising channel provider uses the invention to provide a first phase of a marketing or advertising campaign, the resulting advertising efficacy information may be used to refine target individuals for subsequent phases of such a campaign or other campaigns.

It should be appreciated that various cost models may be implemented using the invention embodiments depending on the costs of distributing promotional material in a campaign and the value of responses to the promotional material. For example, if the cost of distributing promotional material to mobile device users is small compared to the profit achievable if a mobile device user responds to the promotional material, an advertising channel provider may elect to distribute dummy promotional material (i.e., promotional material not associated with a particular product or service but similar to promotional material to be sent in an advertising campaign) to a randomly or quasi-randomly selected group of mobile device users to generate response data for analysis by the feedback analysis system prior to distributing the advertiser's promotional material.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that the term “promotional material” is meant to include any one of or combination of text, pictures, audio, video, links to web-sites or other locations of information, telephone numbers, electronic mail addresses, downloadable files including but not limited to audio files including ring tones, songs, etc, computer implemented games, video files, etc.

It should be understood that profile attributes used by the feedback analysis system may include information provided by a mobile device user in response to first promotional information; for example, a user may fill in a entry form for a prize lottery contest, wherein the entry form includes a home address and user interests or user preferences. Alternatively, or in addition, the profile attributes may be information that is already available regarding one or more mobile device users as a result of them signing up for a service, e.g., an instant messaging service or mobile phone service; for example, in return for free services or reduced cost services, a user may provide information about their interests and preferences. In turn that information may be referenced by the feedback analysis system when analyzing response rates to promotional information and determining correlations with both specified and non-specified attributes.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of advertisers, advertising channel provider(s), network providers, marketing organizations, etc.

Further, it should be understood that, in accordance with at least one embodiment of the invention, system components may be implemented together or separately and there may be one or more of any or all of the disclosed system components. For example, feedback analysis functionality and/or components may be provided by equipment and/or software operated by an advertisement operator and/or equipment and/or software operated and/or controlled by an advertiser. Further, one or more advertisers may use, control or communicate with feedback components to perform their own analyses. System components may be either dedicated systems receiving feedback information and campaign related profiles and non related profiles form advertisement management system or such functionality may be implemented as virtual systems implemented on general purpose equipment via software implementations. Moreover, distribution of feedback information and profiles may be performed via an Application Program Interface (API) or any other methodology that is technologically and/or commercially advantageous.

As a result, it will be apparent for those skilled in the art that the illustrative embodiments described are only examples and that various modifications can be made within the scope of the invention as defined in the appended claims.

1. A method of managing distribution of material to a plurality of mobile devices, the method comprising:
distributing first material to a plurality of mobile devices;
receiving at least one response to the first material;
analyzing the at least one response to the first material to determine at least one profile attribute associated with the at least one response, wherein the determined at least one profile is different than an indication that a response to first material was received; and
distributing subsequent material to a plurality of mobile devices based on the determined at least one profile attribute.

2. The method of claim 1, wherein the at least one profile attribute is different than and not necessarily included as a subset of any attribute used for distributing the first material, if a profile attribute is used for distributing the first material.

3. The method of claim 1, wherein the distributing first material is performed based on at least one pre-selected target profile attribute associated with a target audience.

4. The method of claim 3, wherein the at least one pre-selected target profile attribute is provided by an advertiser.

5. The method of claim 3, wherein the at least one pre-selected target profile attribute is provided by an advertising channel provider.

6. The method of claim 3, wherein the at least one pre-selected target profile attribute indicates an attribute of a mobile device or mobile device user.

7. The method of claim 1, wherein analyzing the at least one response to the first material generates profile information for each mobile device and/or mobile device user responding to the first material.

8. The method of claim 7, wherein distribution of subsequent material is performed based on the at least one determined profile attribute and profile information generated by the analysis of the at least one response to the first material.

9. The method of claim 1, wherein the first material is the same format of material as the subsequent material.

10. The method of claim 9, wherein the first material is distributed via SMS.

11. The method of claim 9, wherein the first material is distributed via MMS.

12. The method of claim 1, wherein the first material is the same type of material as the subsequent material.

13. The method of claim 12, wherein the first material includes text.

14. The method of claim 12, wherein the first material includes video.

15. The method of claim 12, wherein the first material includes audio.

16. The method of claim 1, wherein the distribution of the first material is performed randomly.

17. The method of claim 1, wherein the distribution of the first material is performed based on at least one pre-selected profile attribute.

18. The method of claim 17, wherein the analysis of the at least one response to the first material determines at least one profile attribute that is different than and not necessarily included as a subset of any attribute pre-selected for use in distributing the first material and the analysis compares responsiveness to the first material based on the determined at least one profile attribute and the pre-selected profile attribute.

19. The method of claim 18, further comprising:
determining a cost associated with distribution of the subsequent material using the pre-selected profile attribute; and
determining a cost associated with distribution of the subsequent material based on the determined at least one profile attribute.

20. The method of claim 1, wherein receipt of at least one response to the first material is performed via an Application Program Interface.

21. A method of analyzing efficacy of distribution of material to a plurality of mobile devices, the method comprising:
receiving at least one response to first material distributed to a plurality of mobile devices; and
analyzing the at least one response to the first material to determine at least one profile attribute associated with the at least one response, wherein the determined at least one profile is different than an indication that a response to first material was received.

22. The method of claim 21, wherein the at least one profile attribute is different than and not necessarily included as a subset of any attribute used for distributing the first material, if a profile attribute is used for distributing the first material.

23. The method of claim 21, wherein the first material is distributed based on at least one pre-selected target profile attribute associated with a target audience.

24. The method of claim 23, wherein the at least one pre-selected target profile attribute is provided by an advertiser.

25. The method of claim 23, wherein the at least one pre-selected target profile attribute is provided by an advertising channel provider.

26. The method of claim 23, wherein the at least one target profile attribute indicates an attribute of a mobile device or mobile device user.

27. The method of claim 21, wherein analyzing the at least one response to the first material generates profile information for each mobile device and/or mobile device user responding to the first material.

28. The method of claim 21, wherein the first material is distributed randomly.

29. The method of claim 21, wherein the first material is distributed based on the at least one profile attribute associated with a mobile device and/or mobile device user to receive the first material.

30. The method of claim 30, wherein the analysis of the at least one response to the first material determines at least one profile attribute that is different than and not necessarily included as a subset of any attribute pre-selected for use in distributing the first material and the analysis compares responsiveness to the first material based on the determined at least one profile attribute and the pre-selected profile attribute.

31. The method of claim 31, further comprising:
determining a cost associated with distribution of the subsequent material using the pre-selected profile attribute; and
determining a cost associated with distribution of the subsequent material based on the determined at least one profile attribute.

32. The method of claim 21, wherein receipt of at least one response to the first material is performed via an Application Program Interface.

33. A system for managing distribution of material to a plurality of mobile devices, the system comprising:
an advertising management system configured to store first and subsequent material to a plurality of mobile devices;
a gateway, coupled to the advertising management system and configured to distribute first material to the plurality of mobile devices at the direction of the advertising management system; and
a feedback analysis system configured to receive at least one response to the first material and to analyze the at least one response to the first material to determine at least one profile attribute associated with the at least one response, wherein the determined at least one profile is different than an indication that a response to first material was received,
wherein, the advertising management system is configured to direct the gateway to distribute subsequent material to a plurality of mobile devices based on the determined at least one profile attribute.

34. The system of claim 33, wherein the at least one profile attribute is different than and not necessarily included as a subset of any attribute used for distributing the first material, if a profile attribute is used for distributing the first material.

35. The system of claim 33, wherein the advertising management system is configured to distribute first material based on at least one pre-selected target profile attributes associated with a target audience.

36. The system of claim 35, wherein the at least one pre-selected target profile attribute is provided by an advertiser.

37. The system of claim 35, wherein the at least one pre-selected target profile attribute is provided by an advertising channel provider.

38. The system of claim 35, wherein the at least one pre-selected target profile attribute indicates an attribute of a mobile device or mobile device user.

39. The system of claim 35, wherein the feedback analysis system is configured to analyze the at least one response to the first material and generate profile information for each mobile device and/or mobile device user responding to the first material.

40. The system of claim 39, wherein the advertising management system is configured to perform distribution of subsequent material based on the at least one determined profile attribute and profile information generated by the analysis of the at least one response to the first material.

41. The system of claim 33, wherein the first material is the same format of material as the subsequent material.

42. The system of claim 41, wherein the first material is distributed via SMS.

43. The system of claim 41, wherein the first material is distributed via MMS.

44. The system of claim 33, wherein the first material is the same type of material as the subsequent material.

45. The system of claim 44, wherein the first material includes text.

46. The system of claim 44, wherein the first material includes video.

47. The system of claim 41, wherein the first material includes audio.

48. The system of claim 33, wherein the distribution of the first material is performed randomly.

49. The system of claim 33, wherein the distribution of the first material is performed based on a pre-selected at least one profile attribute.

50. The system of claim 33, wherein the feedback analysis system is configured to determine at least one profile attribute that is different than and not necessarily included as a subset of any pre-selected attribute for use in distributing the first material and the feedback analysis system compares responsiveness to the first material based on the determined at least one profile attribute and at least one pre-selected profile attribute used to distribute the first material.

51. The system of claim 33, further comprising a billings system that is configured to determine a cost associated with distribution of the subsequent material using a pre-selected profile attribute used for distribution of the first material, and to determine a cost associated with distribution of the subsequent material based on the determined at least one profile attribute.

52. The system of claim 33, wherein receipt of at least one response to the first material is performed via an Application Program Interface.

53. A system for analyzing efficacy of distribution of material to a plurality of mobile devices, the system being configured to:
receive at least one response to first material distributed to a plurality of mobile devices; and
analyze the at least one response to the first material to determine at least one profile attribute associated with the at least one response, wherein the determined at least one profile is different than an indication that a response to first material was received.

54. The system of claim 53, wherein the at least one profile attribute is different than and not necessarily included as a subset of any attribute used for distributing the first material, if a profile attribute is used for distributing the first material.

55. The system of claim 53, wherein the first material is distributed based on at least one target profile attribute associated with a target audience.

56. The system of claim 55, wherein the at least one target profile attribute is provided by an advertiser.

57. The system of claim 55, wherein the at least one target profile attribute is provided by an advertising channel provider.

58. The system of claim 55, wherein the at least one target profile attribute indicates an attribute of a mobile device or mobile device user.

59. The system of claim 55, wherein the analysis of the at least one response to the first material generates profile information for each mobile device and/or mobile device user responding to the first material.

60. The system of claim 53, wherein the first material is distributed randomly.

61. The system of claim 53, wherein the first material is distributed based on the at least one profile attribute associated with a mobile device and/or mobile device user to receive the first material.

62. The system of claim 53, wherein the analysis of the at least one response to the first material determines at least one profile attribute that is different than and not necessarily included as a subset of any attribute pre-selected for use in distributing the first material and the analysis compares responsiveness to the first material based on the determined at least one profile attribute and the pre-selected profile attribute.

63. The system of claim 53, wherein receipt of at least one response to the first material is performed via an Application Program Interface.

64. An article of manufacture for analyzing efficacy of distribution of material to a plurality of mobile devices, the article of manufacture comprising a machine readable medium containing one or more programs which when executed implement the steps of:
receiving at least one response to first material distributed to a plurality of mobile devices; and
analyzing the at least one response to the first material to determine at least one profile attribute associated with the at least one response, wherein the determined at least one profile is different than an indication that a response to first material was received.

65. The article of manufacture of claim 64, wherein the at least one profile attribute is different than and not necessarily included as a subset of any attribute used for distributing the first material, if a profile attribute is used for distributing the first material.
